(19) United States
(12) Patent Application Publication
(10) Pub. No.: US 2015/0155956 A1
(43) Pub. Date: Jun. 4, 2015

(54) PROCEDURE AND ARRANGEMENT FOR TESTING THE OPERATIONAL STATE OF A PROCESS TOOL

(71) Applicant: Endress+Hauser Conducta GmbH + Co. KG, Weil am Rhein (DE)

(72) Inventor: Dietrich Wentland, Stuttgart (DE)

(21) Appl. No.: 14/559,381

(22) Filed: Dec. 3, 2014

(30) Foreign Application Priority Data
Dec. 3, 2013 (DE) DE 102013113368.1

(51) Int. Cl. H04B 17/19; H04B 17/16; H04W 4/00

(52) U.S. Cl. CPC H04B 17/19; H04W 4/008; H04B 17/16

(57) ABSTRACT

Methods and apparatus are disclosed for testing an operating state of a processing tool comprising an electrode with a transmitter having a sensor interface for connecting a sensor. A simulated sensor signal is output to the transmitter via the sensor interface, and the simulated sensor signal is converted into a measured value in the transmitter, where it is checked for correctness. The method does not require service personnel to be present on site, and after the sensor has been removed from the sensor interface, the simulated sensor signal is produced by an external electrode unit and is transmitted via the sensorless sensor interface to the transmitter.

### REFERENCE TO RELATED APPLICATION

This application claims priority to German patent application No. DE102013113368.1, filed Dec. 3, 2013, the entire content of which is incorporated herein by reference.

### FIELD OF THE INVENTION

This invention relates to method and apparatus for testing the operating state of a process tool, wherein a processing system comprises a measuring chain with a transmitter, and a sensor interface for connecting a sensor, whereby a simulated sensor signal is output to the transmitter via the sensor interface in the transmitter, and whereby the simulated sensor signal is converted into a measured value that is checked for correctness, as well as a test arrangement for executing the procedure.

### BACKGROUND OF THE INVENTION

In process control engineering, sensors are positioned in an environment wherein physical and/or chemical properties are to be measured. A transmitter, positioned near the sensor, converts and further processes the sensor signal. Together, the sensor and the transmitter form an electrode. In the context of the present invention, a primary sensor signal transmission path is provided that depends on a parameter to be measured, which is sent to a unit downstream from the sensor, wherein the downstream unit receives either the sensor signal or a processed sensor signal in order to further process this or to respond to it. The electrode often includes convertor modules, which are connected to the sensor module via suitable interfaces, and which prepare the primary signal for the sensor module and which forward the signal in another form.

Transmitters are installed in position, configured according to the measuring task, and connected to a process control system. To check whether the installation was done correctly, in place of the sensor, a sensor simulator is often connected to the transmitter via the sensor interface.

This type of sensor simulator, used for testing the behavior of a processing tool as a function of the signals in a sensor, is described in DE 2005 041 427 A1. This arrangement causes the signals from the sensor simulator to simulate sensor signals. The processing tool has at least one electrode with a sensor interface for connecting the sensor, whereby the sensor simulator—which outputs signals to the transmitter—is connected in place of the sensor.

DE 10 2008 050 612 A1 discloses a method for testing the behavior of a processing tool by means of a sensor simulator, in which the sensor simulator is connected to the sensor interface and, using an input function on the transmitter, selects the sensor signal that is to be simulated. Next, the selected simulated sensor signal is transmitted from the transmitter to the sensor simulator. In the sensor simulator, the simulated sensor signal is assigned a series of simulated sensor signals, which are transmitted back to the transmitter.

The disadvantage in the above-mentioned solutions is that the electrode operability test has to be carried out by service personnel who must be present on site at the measuring point.

### SUMMARY OF THE INVENTION

This invention is thus based on the object of specifying a method and a test assembly for testing an operating state of a processing tool, which requires the presence of staff personnel on site. According to the invention, the object is achieved by the fact that after removing the sensor from the sensor interface, the simulated sensor signal is generated by an external electrode unit, and is sent to the transmitter via the sensorless sensor interface. This has the advantage that the service staff that verifies the functionality of the newly installed electrode does not have to be present at the point where the measuring is carried out. A unit would be provided under an external electrode unit, which exists outside of the electrode and performs no functions within the electrode.

Advantageously, the simulated sensor signal is transmitted via a cable or wirelessly to the sensor interface. Thus, the simulated sensor signal can be generated simply by the external electrode unit via wireless transmission or transmission over a cable configured as a field bus, which is part of the processing tool. The external electrode unit need not be located near the newly installed electrode, but rather, the service staff are able to operate it remotely.

In one embodiment, the simulated sensor signal is produced by an external electrode unit in the form of a handheld device. This application is particularly advantageous when a wireless connection exists between the handheld device and the sensor interface. This connection can be reliably achieved via Bluetooth.

In an alternative embodiment of the invention, the simulated sensor signal is generated by a process control system and is transmitted to the sensor interface via a field bus system. Again, existing elements are used to test a newly installed electrode in the processing tool. Of particular advantage is the generation of a simulated sensor signal in the process control system, which can be checked before a new measuring site is put into operation. In particular, if the transmitter is also connected to the process control system, the result of the analysis generated in the transmitter can be sent directly to the process control system for evaluation. Information about the electrode's functioning efficiency is thus immediately available in the process control system.

An enhancement of the invention relates to a test device for testing an operating state of the processing tool. Again, the processing tool includes an electrode with a transmitter, which has a sensor interface for connecting a sensor, whereby a simulated sensor signal is output to the transmitter via the sensor interface. At a test setup where the service personnel does not need to check the electrode on site, an external electrode unit that produces the simulated sensor signal is connected to a receiving device, which forms part of the sensor interface. Using the receiving device, a signal-transmitting connection can thus be produced over long distances between the transmitter and the external electrode unit, without requiring that service personnel remain on-site where the electrode is located.

Advantageously, the sensor interface is configured as a connector coupling which comprises a plug that is connected to the transmitter via a cable connection, and the receiver is part of a mating connector for the connector coupling. Thus, only the mating connector is additionally equipped with the receiver to ensure remote transmission of simulated sensor signals from the external electrode unit to the transmitter.

The external electrode unit may be a handheld device that has at least one microprocessor, a display and a control panel that allows the handheld device to be connected wirelessly or via a cable to the receiver. Using a handheld device, service personnel can check the newly installed electrode for functionality from any point in the processing plant.

Alternatively, the external electrode unit may be disposed in the process control system. Production of a simulated sensor signal in the process control system is especially advantageous because in the process control system all measuring results from the processing plant converge for evaluation. This eliminates the need for separate electronic test devices, which reduces test setup costs.

In one version, the process control system is connected to the receiver via a field bus system. Field buses are typically available in the processing tool, and therefore only have to be connected to the receiving device. Hard buses, FF, Profibuses, Modbuses, Ethernet, etc., can be used as field buses. Connecting the field bus to the sensor interface via a cable has the additional advantage of a power supply of the transmitter.

As a variant, the receiver is configured as a Bluetooth interface. Bluetooth interfaces are conventional, cost-effective interfaces that can be integrated with the sensor interface.

The invention permits numerous embodiments explained in greater detail with reference to the figures shown in the drawings.

### BRIEF DESCRIPTION OF THE DRAWINGS

FIG. 1 shows an electrode as it is configured within a process control system at a processing plant and at a particular measurement point;

FIG. 2 illustrates how a simulated sensor signal is generated and forwarded via a Bluetooth wireless interface to a transmitter;

FIG. 3 shows a sensor signal produced by a different sensor unit configured in a measurement;

FIG. 4 illustrates an interface to a field bus system; and

FIG. 5 shows how several sensors may be connected to the field bus through a field bus adapter.

### DETAILED DESCRIPTION OF THE INVENTION

In the drawings, the same features are referenced using the same reference numerals, as follows:

### REFERENCE NUMERALS

1 Electrode
2 Sensor
3 Sensor interface
3.1 Connector
3.2 Mating connector
4 Connector cable
5 Transmitter
6 Display
7 Bluetooth interface
8 Handheld device
9 Sensor
10 Sensor interface
10.1 Connector
10.2 Mating connector
11 Transmitter/channel
12 Electronic receiving device
13 Cable
14 Fieldbus adapter
15 Process control system

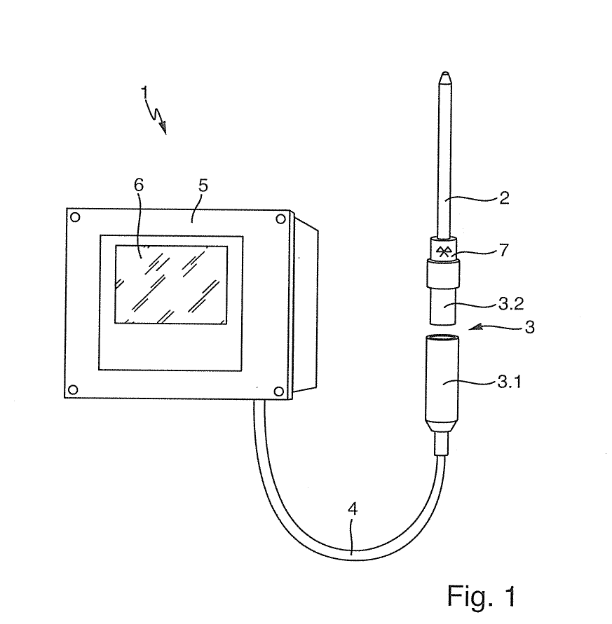

FIG. 1 shows an electrode 1, as it is configured within a process control system at a processing plant and at a particular measurement point. A sensor 2 is connected to a transmitter 5 via a sensor interface 3 and a cable connection 4. Both the sensor 2 and the transmitter 5 are positioned at a location where a process parameter should be measured. This process parameter is detected by the sensor 2, which forwards its output signals it to the transmitter 5, which processes these sensor signals and converts them into a measuring result. The result can be read locally on the display 6, or can be forwarded to a remote process control system (not shown).

There is a connector coupling at the sensor interface 3, which comprises a connector 3.1 and a mating connector 3.2. The connector 3.1 is connected to the transmitter 5 via the connecting cable 4, while the mating connector 3.2 includes a complementary plug-in element that is fitted into the connector 3.1. This connector coupling represents a galvanically isolated, inductively coupled connector, which is described for example in EP 1206012 A2. The mating connector 3.2 additionally includes a Bluetooth interface 7.

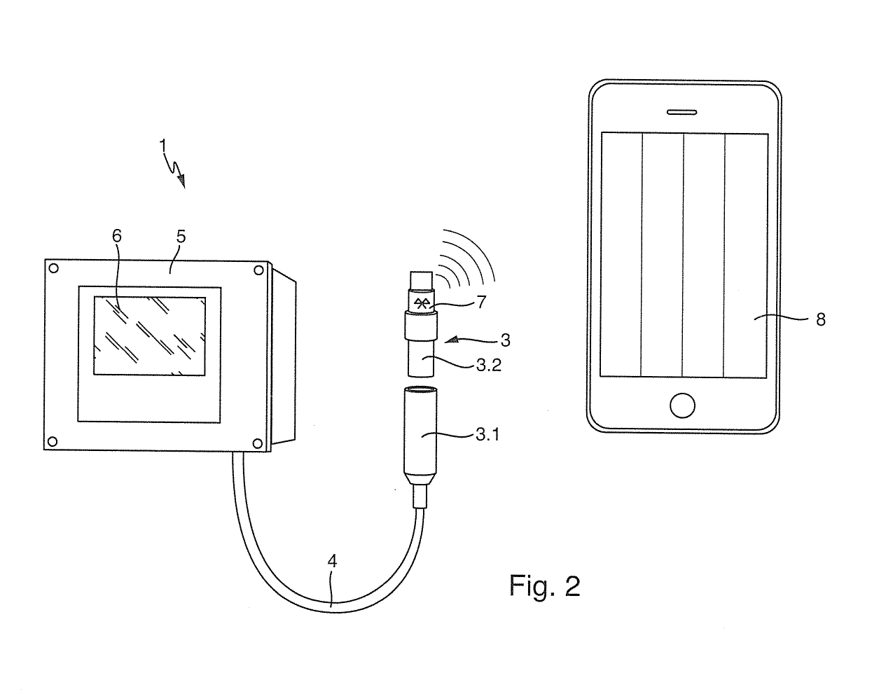

If electrode 1 has recently been installed in a processing tool, it must be tested before being put into operation to determine whether the sensor signals that sensor 2 supplies are actually correct. For this purpose, the sensor 2 is removed from the sensor interface 3. As shown in FIG. 2, by using an external electrode unit, e.g. a handheld device 8, a simulated sensor signal is generated and forwarded to the sensor interface 3 via the Bluetooth wireless interface 7, and then on to the transmitter 5. The transmitter 5 processes the simulated sensor signal and determines a measured value that is passed to the process control system 15 which then compares it with an expected reading. If the two values match, then the new electrode 1 is enabled for operation.

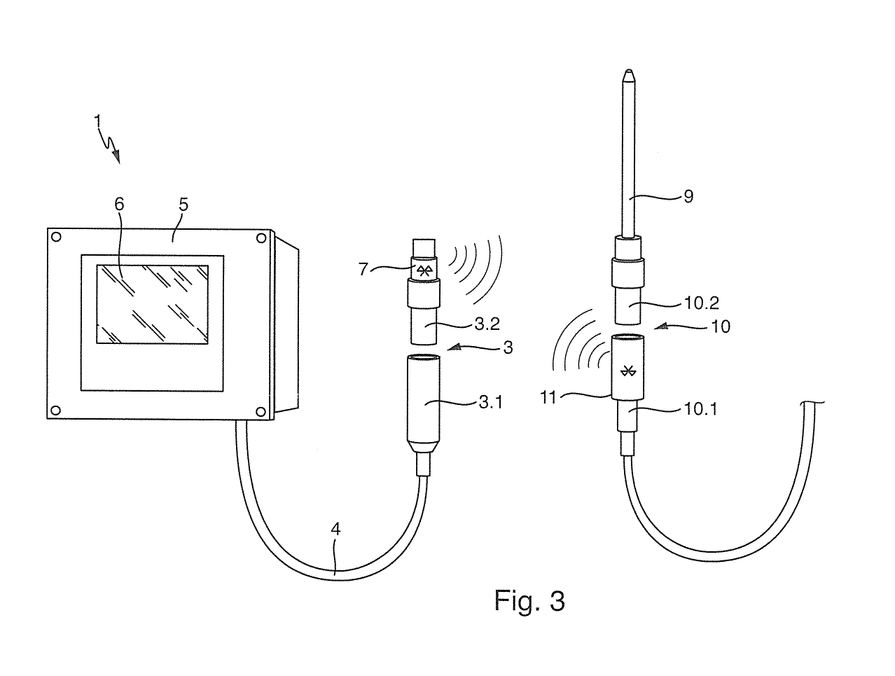

In another arrangement, the sensor signal is produced by a different sensor unit, which is also configured in the region to be measured, as shown in FIG. 3. A second connector 10.1 includes a transmitter 11 for wireless transmission of the sensor signal. The sensor signal, transmitted wirelessly from the transmitter 11, is received by the port 7 for the first mating connector 3.2 of the sensor interface 3 and transferred to the converter 5 for evaluation. To ensure reliable signal transmission between the external electrode units that generate the sensor signal and the sensor interface, the solution shown in FIG. 3, works by utilizing a different transmission protocol of wireless signals, e.g. IEE 8021504.

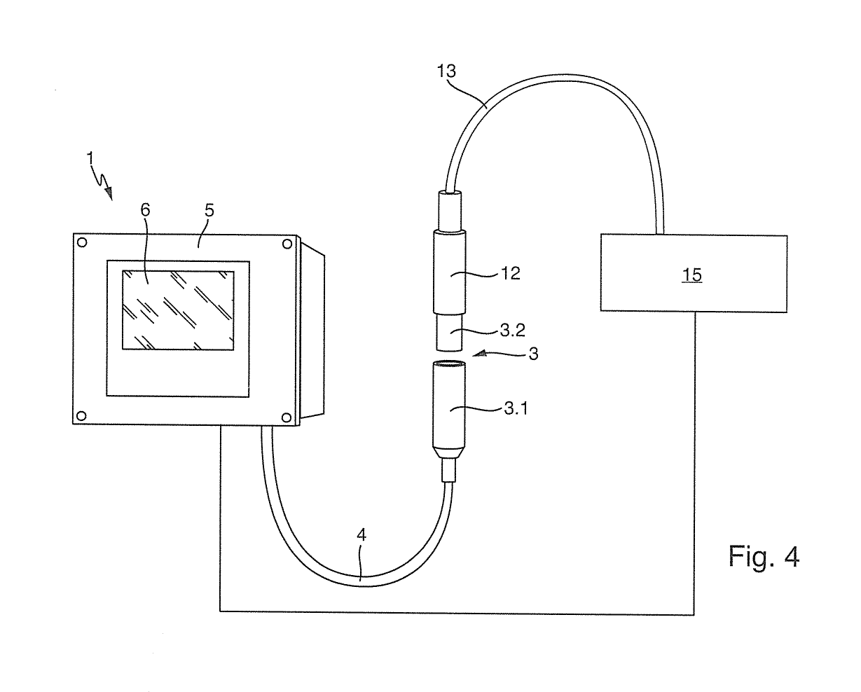

As shown in FIG. 4, instead of the Bluetooth interface 7, an electronic receiving device 12 may be installed in the mating connector 3.2 for communication with a field bus system, such as a Hardbus, Profibus, Modbus or Ethernet is connected via a cable 13. This bus represents an existing bus system present in the processing tool, which is connected to the process control system 15. As such, in this case, the simulated sensor signal is generated in the process control system 15 and is forwarded via the field bus to the electronic receiving device 12 in the sensor interface 3. When coupling the sensor interface 3, the simulated sensor signal generated by the process control system 15 is transferred into the transmitter 5, where it is evaluated.

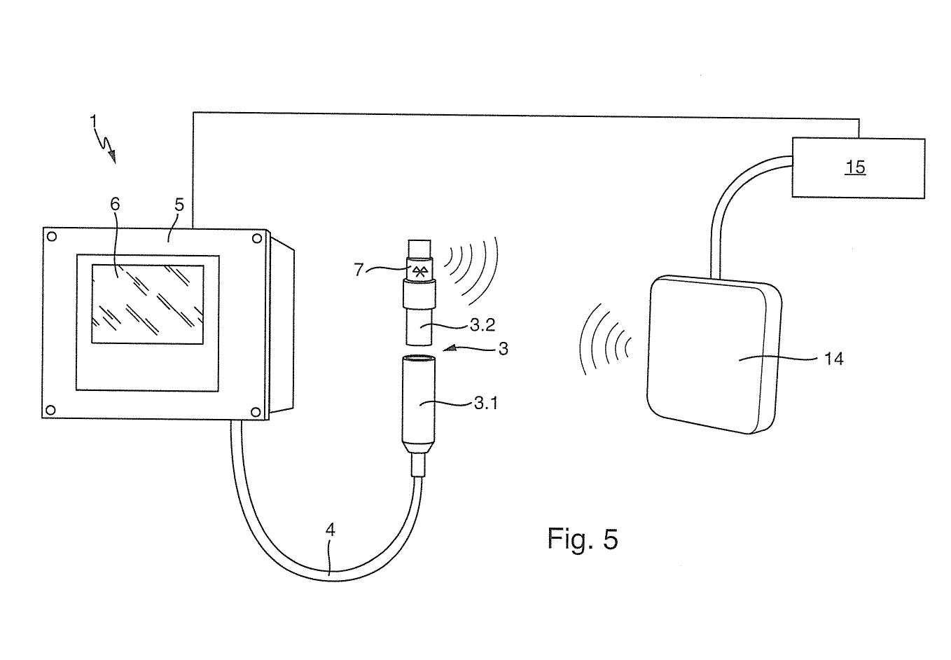

It is also possible that several sensors are connected to the field bus. This should preferably be done via a field bus adapter 14, as shown in FIG. 5, to which the cable leading to the field bus 13 is connected. The field bus adapter 14 can emit a simulated sensor signal to all sensors involved. This simulated sensor signal is received by the Bluetooth interfaces 7 located in the respective electrode 1 and which are installed in the respective mating connectors 3.2 for the sensor interface 3. Since each transmitter 5 for a sensor is connected to the process control system 15, the process control system 15 may include the measurement results, which the transmitters 5, due to the transfer of the simulated sensor signal, receives, analyzes and evaluates, and use to further test the newly installed electrodes. However, this solution is not limited to just verifying the newly installed electrodes, but can be reused during troubleshooting to identify and exclude possible errors.

1. A method of testing the operational state of a processing tool having an electrode including a sensor coupled to a transmitter through a sensor interface, the method comprising the steps of:
disconnecting the sensor from the sensor interface;
generating a simulated sensor signal using an external electrode unit;
receiving the simulated sensor signal at the sensor interface;
transferring the simulated sensor signal to the transmitter;
converting the simulated sensor signal to a measured value at the transmitter; and
determining the correctness of the measured value.

2. The method according to claim 1, wherein the simulated sensor signal is transferred to the transmitter through a cable or wirelessly to the sensor interface.

3. The method according to claim 1, wherein the external electrode unit is configured as a handheld device.

4. The method according to claim 1, wherein the simulated sensor signal is produced by a process control system and transferred to the sensor interface via a bus system.

5. A system for testing an operational status of a processing tool comprising an electrode with a transmitter and at least one sensor interface for receiving a sensor, the system comprising:
an external electrode unit operative to generate a simulated sensor signal; and
a receiving device adapted for coupling to the sensor interface to receive the simulated sensor signal for communication to the transmitter.

6. The system of claim 5, wherein the sensor interface is a coupling including a connector connected to the transmitter via a cable, and the receiving device forms part of a mating connector on the connector coupling.

7. The system of claim 5, wherein the external electrode unit is configured as a handheld device having at least one microprocessor, a display and a control panel, and wherein the handheld device is connected wirelessly or via a cable to the receiving device.

8. The system of claim 5, wherein the external electrode unit is a process control center.

9. The system of claim 6, wherein the external electrode unit is a process control center.

10. The system of claim 5, wherein the external electrode unit is a process control center connected to the receiving device via a field bus system.

11. The system of claim 6, wherein the external electrode unit is a process control center connected to the receiving device via a field bus system.

12. The system of claim 5, wherein the receiving device is configured as a Bluetooth interface.

13. The system of claim 6, wherein the receiving device is configured as a Bluetooth interface.

14. The system of claim 7, wherein the receiving device is configured as a Bluetooth interface.

15. The system of claim 8, wherein the receiving device is configured as a Bluetooth interface.

16. The system of claim 9, wherein the receiving device is configured as a Bluetooth interface.

17. The system of claim 10, wherein the receiving device is configured as a Bluetooth interface.

18. The system of claim 11, wherein the receiving device is configured as a Bluetooth interface.
